(19) United States
(12) Patent Application Publication
(10) Pub. No.: US 2025/0300976 A1
(43) Pub. Date: Sep. 25, 2025

(54) SYSTEMS AND METHODS FOR ENCRYPTING A TUNNEL-ENCAPSULATED MESSAGE WITH AN INTERIM HEADER FOR A FAST DECRYPTION

(71) Applicant: Cisco Technology, Inc., San Jose, CA (US)

(72) Inventors: Aviran Kadosh, Moreshet (IL); Anbu Chezhian Gunalan, San Jose, CA (US); Chennakesava Reddy Gaddam, Bengaluru (IN); Anand Sridharan, Fremont, CA (US); Mohit Vashisht, Pleasanton, CA (US)

(21) Appl. No.: 18/793,240

(22) Filed: Aug. 2, 2024

Related U.S. Application Data
(60) Provisional application No. 63/567,618, filed on Mar. 20, 2024.

(51) Int. Cl. H04L 9/40

(52) U.S. Cl. CPC H04L 63/0485; H04L 63/029

(57) ABSTRACT

In one embodiment, a method by a first network node includes accessing a first message that is to be forwarded to a second network node after being encrypted using an ESP encryption, determining that an outer-most header of the first message is lack of information regarding a length of the first message, constructing a second message by adding a particular header that mimics at least a part of an IPv4 header at a beginning of the first message, where the particular header includes a length field indicating a combined length of the particular header and the first message, encrypting the second message using the ESP encryption, and forwarding the ESP encrypted second message to the second network node as a UDP packet, wherein at least a field in a UDP header of the UDP packet indicates that the second message comprises the particular header and ESP-encrypted.

### CROSS-REFERENCE TO RELATED APPLICATIONS

This application claims benefit of U.S. Provisional Patent Application No. 63/567,618 filed Mar. 20, 2024, and entitled “SYSTEMS AND METHODS FOR ENCRYPTING A TUNNEL-ENCAPSULATED MESSAGE WITH AN INTERIM HEADER FOR A FAST DECRYPTION,” which is incorporated herein by reference.

### TECHNICAL FIELD

The present disclosure relates computer networking, and more particularly, to encrypting a tunnel-encapsulated message with an interim header for a fast decryption.

### BACKGROUND

Various types of tunneling are widely used. Demands for secure tunnels that can spread across multiple ports of an endpoint, with line rate encryption for Internet Protocol (IP) traffic have been increased. As different types of tunneling are used based on their own needs, the secure tunnel solution should not impose any limitation on the supported tunnel types. Widely used tunneling protocols may include, but not limited to, Virtual extensible Local-Area Network (VxLAN), Multiprotocol Label Switching (MPLS), Generic User Datagram Protocol Encapsulation (GUE), Generic Network Virtualization Encapsulation (GENEVE), Generic Routing Encapsulation (GRE), or Network Virtualization using GRE (NVGRE). Depending on the specific deployments, both Media Access Control Security (MACsec) and Internet Protocol Security (IPsec) may offer distinct advantages and disadvantages for supporting any Inner packet formats. When a message is encrypted using Encapsulating Security Payload (ESP) encryption, an ESP header may be inserted before the payload. Also, an ESP trailer may be added after the payload to make the length of payload equal to multiples of four using padding bytes. The ESP trailer also includes the Next Header Field.

During decryption, when an inner IP header presents, the IPsec engine may determine the next-header and the length of the payload by looking at the first K bits, which belongs to a part of the inner IP header of the decrypted payload. On detecting the payload length, the padding bytes may be discarded, and rest of the packet may be processed. This scheme works for any cut-through device which is trying to decrypt the ESP payload at line rate. The ESP trailer does not need to be read to determine padding length and next header. Thus, physical layer (PHY) engine on a cut-through device may support IPsec tunnel mode (IP-in-IP encapsulation) only.

When tunnel-encapsulated packets, such as MPLS, VxLAN, or GUE are encrypted with the ESP encryption, detecting the payload length and the next-header info as described above may not work. With those tunneling protocols, the ESP header may be followed by an MPLS label, VXLAN header, or Ethernet header, which do not contain the version field for header identification and the packet length field.

### BRIEF DESCRIPTION OF THE DRAWINGS

FIG. 1 illustrates example tunneling packet formats.

FIG. 2 illustrates an example ESP packet format.

FIG. 3 illustrates an example modified GRE header format.

FIG. 4 illustrates an example network system for secure delivery of a tunnel-encapsulated message over a public network.

FIG. 5 illustrates an example IPsec message with a payload comprising an interim header.

FIG. 6 illustrates an example method for encrypting a tunnel-encapsulated message by adding a particular header.

FIG. 7 illustrates a computer system, in accordance with some embodiments.

### DESCRIPTION OF EXAMPLE EMBODIMENTS

### Overview

In some embodiments, a method for encrypting a tunnel-encapsulated message may be adding a particular header comprising a field indicating a length of the tunnel-encapsulate message at a beginning of the tunnel-encapsulated message. In particular embodiments, a first network node may access a first message that is to be forwarded to a second network node after being encrypted using an Encapsulating Security Payload (ESP) encryption. The first network node may determine that an outer-most header of the first message is lack of information regarding a length of the first message. In particular embodiments, the first network node may determine that the outer-most header of the first message is not an Internet Protocol version 4 (IPv4) header. In particular embodiments, the first message may be an encapsulated message in accordance with a tunneling protocol. The tunneling protocol may comprise Virtual extensible Local-Area Network (VxLAN), Multiprotocol Label Switching (MPLS), Generic User Datagram Protocol Encapsulation (GUE), Generic Network Virtualization Encapsulation (GENEVE), Generic Routing Encapsulation (GRE), Network Virtualization using GRE (NVGRE) or any suitable tunneling protocol.

In particular embodiments, the first network node may construct a second message by adding a particular header that mimics at least a part of an Internet Protocol version 4 (IPv4) header at a beginning of the first message. The second message may comprise the particular header and the first message. The particular header may comprise a length field indicating a combined length. In particular embodiments, the combined length may be a sum of a length of the particular header and a length of the first message. The particular header may comprise a protocol type field indicating the tunneling protocol. In particular embodiments, the particular header may be a modified GRE header, wherein the particular header comprises 64 bits. First four bits of the particular header may comprise a bit stream of ‘0100.’ A version field of the particular header may indicate one. A reserved field of the particular header may be filled with ones.

In particular embodiments, the first network node may encrypt the second message using the ESP encryption. During the encryption, the first network node may add an ESP header at a beginning of the second message and an ESP trailer including padding bytes at an end of the second message. The first network node may update length fields of an outer IP header and an UDP header based on the encrypted second message and the added bytes. The first network node may forward the ESP encrypted second message to the second network node as a user datagram protocol (UDP) packet. The first network node may set at least a field in a UDP header of the UDP packet with a value indicating that the second message comprises the particular header and ESP-encrypted. In particular embodiments, the at least a field in the UDP header may include a field for a destination port number. In particular embodiments, the first network node may be an IPsec ingress node for the ESP encrypted second message. In particular embodiments, the second network node may be an IPsec egress node for the ESP encrypted second message.

In some embodiments, a method for decrypting a message comprising a particular header and a tunnel-encapsulated message in an efficient manner may be using a decryption hardware based on length information determined from a length field in the particular header. In particular embodiments, the second network node may access a UDP packet comprising a payload that is ESP-encrypted. The payload is to be decrypted to be processed. In particular embodiments, the second network node may be an IPsec egress node for the payload. The payload may include a particular header and a first message. The first message may be an encapsulated message in accordance with a tunneling protocol. The second network node may determine that the payload comprising the particular header may be ESP encrypted based on at least a field in a UDP header of the UDP packet. In particular embodiments, the at least a field in the UDP header may include a field for a destination port number.

In particular embodiments, the second network node may decrypt first N bits of the payload using a decryption hardware. The first N bits of the payload may belong to the particular header. The decryption hardware may treat the first N bits of the payload as a part of an IPV4 header based on contents of the first N bits. In particular embodiments, N may be 32. The second network node may determine a length of the payload excluding an ESP trailer based on a length field value within the first N bits of the payload.

In particular embodiments, the second network node may decrypt the payload using the decryption hardware based on the determined length of the payload. The second network node may separate the particular header and the first message among the payload that is decrypted. In particular embodiments, the reserved field of the particular header may be filled with ones. The second network node may determine that the particular header is to be discarded based at least on the reserved field. The second network node may determine the tunneling protocol based on a value of a protocol type field in the particular header. The second network node may remove an ESP header and the particular header. The second network node may also discard an ESP trailer including padding bytes. The second network node may process the first message in accordance with the determined tunneling protocol.

Technical advantages of some embodiments of this disclosure may include one or more of the following. This disclosure describes systems and methods that encrypt a particular header followed by a tunnel-encapsulated message using ESP encryption. The particular header may provide a total length of the ESP payload. This disclosure also describes systems and methods that decrypt an ESP payload comprising a particular header and a tunnel-encapsulated message. Based on a total length information from the particular header, the decryption may be achieved at a line rate by using the decryption hardware. Thus, some embodiments of this disclosure may allow line rate encryption and decryption of any tunnel-encapsulated message.

Other technical advantages will be readily apparent to one skilled in the art from the following figures, descriptions, and claims. Moreover, while specific advantages have been enumerated above, various embodiments may include all, some, or none of the enumerated advantages.

### EXAMPLE EMBODIMENTS

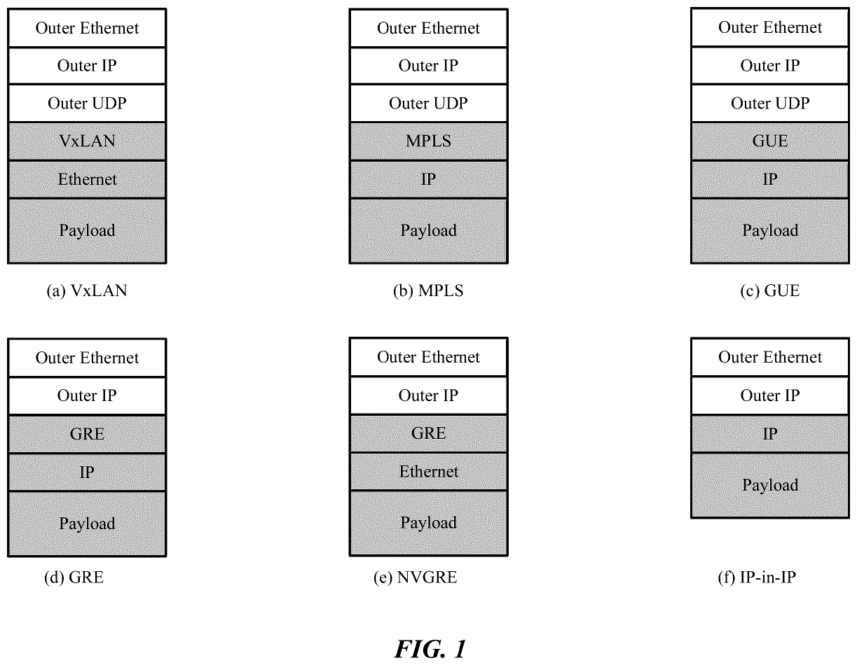

In networking, tunneling is a method for transporting data across a network using protocols that are not supported by that network. Tunneling works by encapsulating packets. In other words, wrapping packets inside of other packets. Tunneling may set up efficient and secure connections between networks, enable the usage of unsupported network protocols, and in some cases allow users to bypass firewalls. Data traveling over a network is divided into packets. A typical packet has two parts: a header indicating the packet's destination, and which protocol the packet uses, and the payload, which is the packet's actual contents. An encapsulated packet is a packet inside another packet. In an encapsulated packet, the header and payload of the first packet goes inside the payload section of the surrounding packet. The original packet itself becomes the payload. Various types of tunneling protocols are widely used for various purposes. FIG. 1 illustrates example tunneling packet formats. (a) shows a packet format for VxLAN, which is a network virtualization technology that attempts to address the scalability problems associated with large cloud computing deployments. While single-tagged Institute of Electrical and Electronics Engineers (IEEE) 802.1Q VLANs provide a limited number of layer-2 VLANs, VXLAN increases scalability up to about 16 million logical networks (using a 24-bit VNID) and allows for layer-2 adjacency across IP networks. (b) shows a packet format for MPLS, which is a method for setting up dedicated paths across networks without relying on the typical routing process. (c) shows a packet format for GUE, which facilitates efficient transport across networks with load-balancing. (d) shows a packet format for GRE, which may be used when a direct or point-to-point connection between two networks or protocols is to be set up, such as in an enterprise where different business units or departments are supported by different networks. (e) shows a packet format for NVGRE, which is another network virtualization technology aiming to address scalability problems associated with large cloud computing deployments. NVGRE is based on GRE. (f) shows a packet format for IP-in-IP encapsulation, which involves an insertion of an outer IP header over the existing IP header. The source and destination address in the outer IP header point to the end points of the IP-in-IP tunnel.

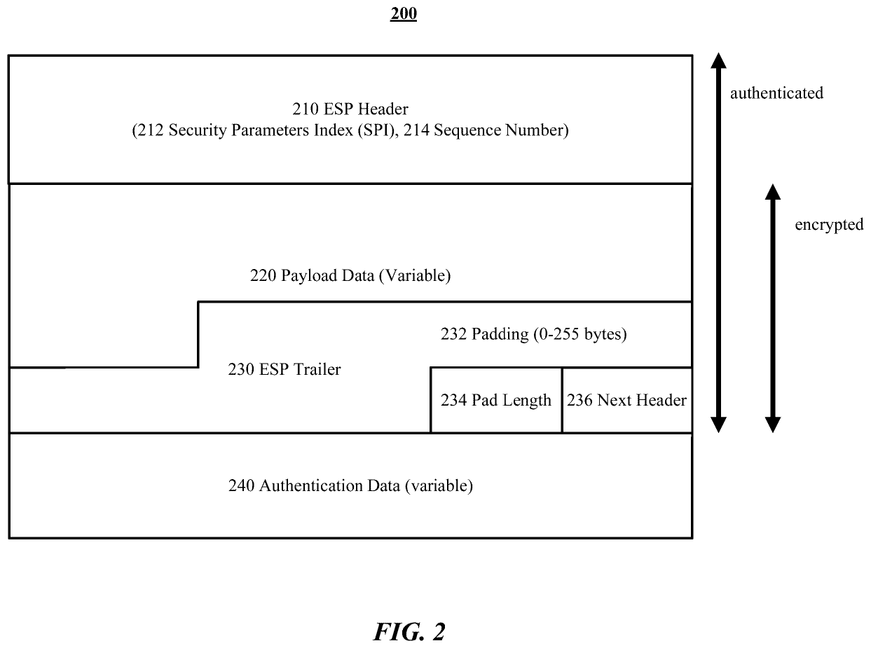

Demands for secure tunnels that can spread across multiple ports of an endpoint, with line rate encryption for Internet Protocol (IP) traffic have been increased. As different types of tunneling are used based on their own needs, the secure tunnel solution should not impose any limitation on the supported tunnel types. Depending on the specific deployments, both Media Access Control Security (MACsec) and Internet Protocol Security (IPsec) may offer distinct advantages and disadvantages for supporting any Inner packet formats. When a message is encrypted using Encapsulating Security Payload (ESP) encryption, an ESP header may be inserted before the payload. Also, an ESP trailer may be added after the payload to make the length of payload equal to multiples of four using padding bytes. The ESP trailer also includes the Next Header Field. FIG. 2 illustrates an example ESP packet format. An ESP packet 200 may consist of an ESP header 210, an encrypted payload 220 and an ESP trailer 230. The authentication data 240 appended at the end as a cryptographic checksum guarantees data integrity. A Security Parameters Index (SPI) 212 within the ESP header 210 may be used by the receiving IPsec peer as an index into its Security Association (SA) database to look up the session keys to be used to decrypt and authenticate the ESP packet 200. The SPI 212 may also be used to determine the IPsec security policy that has to be enforced on the inbound plaintext IP packets after decryption. A sequence number 214 within the ESP header 210 may provide an anti-replay service. The ESP trailer 230 may comprise padding 232, which is added to make the length of payload 220 equal to multiples of four, pad length 234, and Next Header 236 fields.

During decryption, when an inner IP header presents, the IPsec engine may determine the next-header and the length of the payload by looking at the first K bits, which belongs to a part of the inner IP header of the decrypted payload. On detecting the payload length, the padding bytes may be discarded, and rest of the packet may be processed. This scheme works for any cut-through device which is trying to decrypt the ESP payload at line rate. The ESP trailer does not need to be read to determine padding length and next header. Thus, physical layer (PHY) engine on a cut-through device may support IPsec tunnel mode (IP-in-IP encapsulation) only.

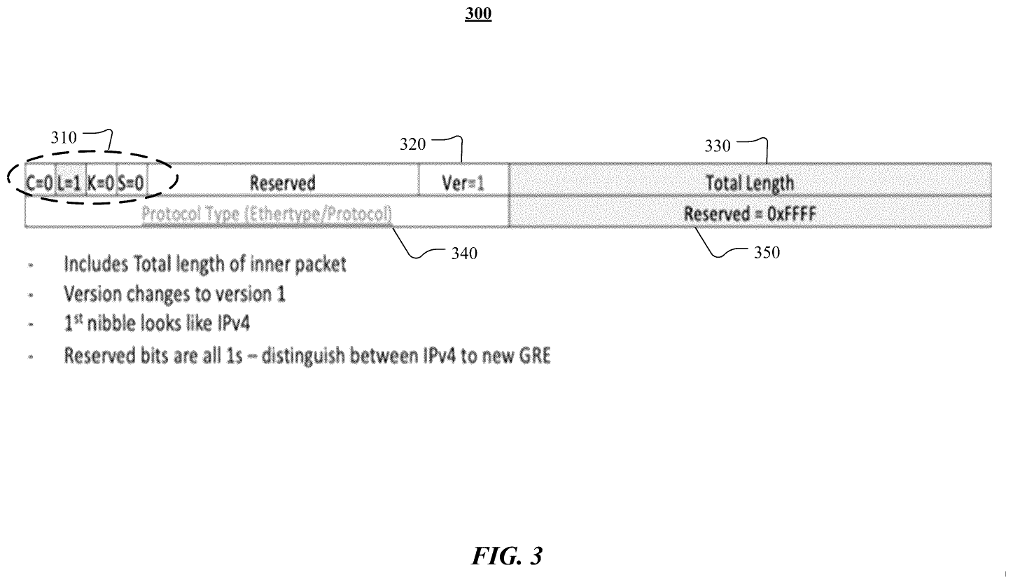

When tunnel-encapsulated packets, such as MPLS, VxLAN, or GUE are encrypted with the ESP encryption, detecting the payload length and the next-header info as described above may not work. With those tunneling protocols, the ESP header may be followed by an MPLS label, VXLAN header, or Ethernet header, which do not contain the version field for header identification and the packet length field. To support line-rate decryption of various encapsulation types on a cut-through device, a modified new GRE header format is introduced without increasing the existing GRE header size and by retaining the UDP Entropy. FIG. 3 illustrates an example modified GRE header 300. First four bits 310 of the modified GRE header 300 may comprise a bit stream of ‘0100’ to mimic an IPV4 header. A version field 320 of the modified GRE header 300 may have a different value from an original GRE header. In particular embodiments, the value of the version field 320 of the modified GRE header 300 may be one. A total length field 330 of the modified GRE header 300 may indicate a combined length of the modified GRE header 300 and the tunnel-encapsulated message that is encrypted with the ESP encryption. A protocol type field 340 of the modified GRE header 300 may indicate a tunneling protocol type associated with the tunnel-encapsulated message. A reserved field 350 of the modified GRE header 300 may be set 1s in order to let a decryption device to distinguish the modified GRE header 300 and an IPV4 header because IPv4 header cannot have all 1s at that position. Although this disclosure describes a particular modified GRE header format, this disclosure contemplates any suitable modified GRE header format.

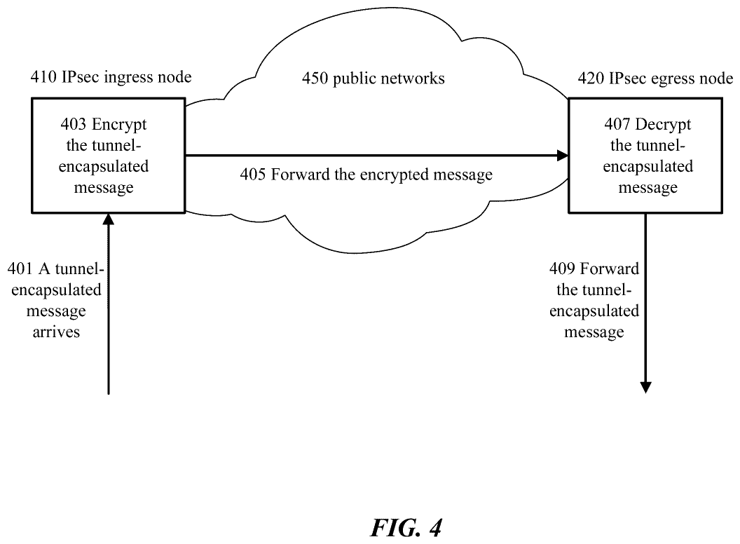

FIG. 4 illustrates an example network system for secure delivery of a tunnel-encapsulated message over a public network. At step 401, a tunnel-encapsulated message arrives at an IPsec ingress node 410. The tunnel-encapsulated message is to be forwarded towards an IPsec egress node 420 over public networks 450. To provide a secure delivery over the public networks 450, the IPsec ingress node 410 may encrypt the tunnel-encapsulated message at step 403. The IPsec ingress node 410 may forward the encrypted tunnel-encapsulated message toward the IPsec egress node 420. Upon receiving the encrypted tunnel-encapsulated message, the IPsec egress node 420 may decrypt the tunnel-encapsulated message at step 407. The IPsec egress node 420 may process the tunnel-encapsulated message according to the tunneling protocol used for the encapsulation. In particular embodiments, the IPsec egress node 420 may forward the tunnel-encapsulated message to a next destination at step 409. Although this disclosure describes secure delivery of a tunnel-encapsulated message over public networks in a particular manner, this disclosure contemplates secure delivery of a tunnel-encapsulated message over public networks in any suitable manner.

In some embodiments, a method for encrypting a tunnel-encapsulated message may comprise adding a particular header comprising a field indicating a length of the tunnel-encapsulate message at a beginning of the tunnel-encapsulated message. In particular embodiments, a first network node may access a first message that is to be forwarded to a second network node after being encrypted using an Encapsulating Security Payload (ESP) encryption. The first network node may determine that an outer-most header of the first message is lack of information regarding a length of the first message. In particular embodiments, the first network node may determine that the outer-most header of the first message is not an Internet Protocol version 4 (IPv4) header. In particular embodiments, the first message may be an encapsulated message in accordance with a tunneling protocol. The tunneling protocol may include, but not limited to, VxLAN, MPLS, GUE, GENEVE, GRE, NVGRE or any suitable tunneling protocol. As an example and not by way of limitation, the IPsec ingress node 410 may access a tunnel-encapsulated message. The tunnel-encapsulated message is an encapsulated message in accordance with a tunneling protocol. The tunnel-encapsulated message is to be forwarded to the IPsec egress node 420 over the public networks 450. Thus, the IPsec ingress node 410 may decide to encrypt the tunnel-encapsulated message using the ESP encryption. The IPsec ingress node 410 may determine that the IPsec egress node 420 may not determine the length of the tunnel-encapsulated message based on the outer-most header of the tunnel-encapsulated message. In particular embodiments, the IPsec ingress node 410 may determine that the outer-most header of the tunnel-encapsulated message is not an IPV4 header. As the IPsec egress node 420 is a cut-through device, the IPsec ingress node 410 may determine that an interim header is to be inserted before encrypting the tunnel-encapsulated message using the ESP encryption. Although this disclosure describes determining that the outer-most header of a tunnel-encapsulated message is lack of information regarding the length of the tunnel-encapsulated message in a particular manner, this disclosure contemplates determining that the outer-most header of a tunnel-encapsulated message is lack of information regarding the length of the tunnel-encapsulated message in any suitable manner.

In particular embodiments, the first network node may construct a second message by adding a particular header that mimics at least a part of an Internet Protocol version 4 (IPv4) header at a beginning of the first message in response to the determination that the outer-most header of the first message is lack of information regarding the length of the first message. The second message may comprise the particular header and the first message. The particular header may comprise a length field indicating a combined length. In particular embodiments, the combined length may be a sum of a length of the particular header and a length of the first message. The particular header may comprise a protocol type field indicating the tunneling protocol. In particular embodiments, the particular header may be a modified GRE header, wherein the particular header comprises 64 bits. First four bits of the particular header may comprise a bit stream of ‘0100.’ A version field of the particular header may indicate one. A reserved field of the particular header may be filled with ones. As an example and not by way of limitation, continuing with a prior example, the IPsec ingress node 410 may construct a second message by adding a modified GRE header 300 to the tunnel-encapsulated message in response to the determination that the outer-most header of the tunnel-encapsulated message is not an IPV4 header. The first four bits 310 of the modified GRE header 300 comprises a bit stream of ‘0100’ to mimic an IPV4 header. A version field 320 of the modified GRE header 300 may be set with one. A total length field 330 of the modified GRE header 300 may indicate a combined length of the modified GRE header 300 and the tunnel-encapsulated message. A protocol type field 340 of the modified GRE header 300 may indicate a tunneling protocol associated with the tunnel-encapsulated message. A reserved field 350 of the modified GRE header 300 may be set 1s in order to let a decryption device to distinguish the modified GRE header 300 and an IPV4 header because IPv4 header cannot have all 1s at that position. Although this disclosure describes constructing a second message by adding an interim header at a beginning of a tunnel-encapsulated message in a particular manner, this disclosure contemplates constructing a second message by adding an interim header at a beginning of a tunnel-encapsulated message in any suitable manner.

In particular embodiments, the first network node may encrypt the second message using the ESP encryption. During the encryption, the first network node may add an ESP header at a beginning of the second message and an ESP trailer including padding bytes at an end of the second message. The first network node may update length fields of an outer IP header and an UDP header based on the encrypted second message and the added bytes. The first network node may forward the ESP encrypted second message to the second network node as a user datagram protocol (UDP) packet. The first network node may set at least a field in a UDP header of the UDP packet with a value indicating that the second message comprises the particular header and ESP-encrypted. In particular embodiments, the at least a field in the UDP header may include a field for a destination port number. In particular embodiments, the first network node may be an IPsec ingress node for the ESP-encrypted second message. In particular embodiments, the second network node may be an IPsec egress node for the ESP-encrypted second message. As an example and not by way of limitation, continuing with a prior example, the IPsec ingress node 410 may encrypt the second message using the ESP encryption. An ESP header 210 is added at the beginning of the second message. An ESP trailer 230 is added at the end of the second message. The ESP trailer 230 may include paddings 232 to make the length of encrypted payload equal to multiples of four, pad length 234, and Next Header 236 fields. The IPsec ingress node 410 may construct a message to be forwarded to the IPsec egress node 420. The message may include an outer IP header, UDP header, and the ESP packet. The source IP address in the outer IP header is an IP address associated with the IPsec ingress node 410. The destination IP address in the outer IP header is an IP address associated with the IPsec egress node 420. The length field in the outer IP header is set with a combined length of the outer IP header, the UDP header, and the ESP packet, wherein the ESP packet comprises the ESP header 210, the encrypted second message including the modified GRE header and the tunnel-encapsulated message, the encrypted ESP trailer 230, and the authentication data 240. A destination port number in the UDP header may be a value indicating that the payload is ESP-encrypted, and that the payload includes a modified GRE header in addition to the tunnel-encapsulated message. Currently the destination port number 4500 may indicate that the payload is ESP-encrypted. A new value may be configured to indicate that the payload is ESP-encrypted, and the payload includes a modified GRE header in addition to the tunnel-encapsulated message. A length field in the UDP header may indicate a length of the UDP header and the ESP packet, wherein the ESP packet comprises the ESP header 210, the encrypted second message including the modified GRE header and the tunnel-encapsulated message, the encrypted ESP trailer 230, and the authentication data 240. Although this disclosure describes encrypting a message using an ESP encryption and forward the encrypted message to the IPsec egress node in a particular manner, this disclosure contemplates encrypting a message using an ESP encryption and forward the encrypted message to the IPsec egress node in any suitable manner.

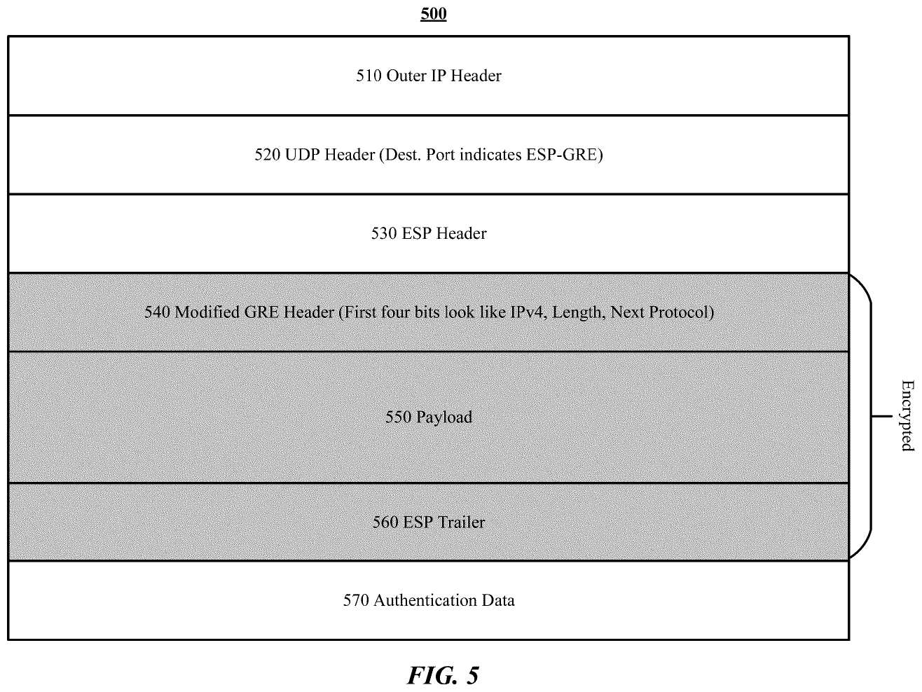

FIG. 5 illustrates an example IPsec message 500 with a payload comprising an interim header. The IPsec message 500 is to be sent from the IPsec ingress node 410 to the IPsec egress node 420. The IPsec message 500 may include an outer IP header 510, an UDP header 520, an ESP header 530, a modified GRE header 540, a payload 550, which would be a tunnel-encapsulated message, an ESP trailer 560, and an authentication data 570. Among them, the modified GRE header 540, the payload 550, and the ESP trailer 560 may be encrypted. The source address in the outer IP header 510 may be an IP address of the IPsec ingress node 410. The destination address in the outer IP header 510 may be an IP address of the IPsec egress node 420. The length field in the outer IP header 510 may indicate a total length of the IPsec message 500. In particular embodiments, the destination port number in the UDP header 520 may indicate that the payload is ESP-encrypted, and the payload includes a modified GRE header. In particular embodiments, one or more other fields in the UDP header 520 may indicate that the payload is ESP-encrypted, and the payload includes a modified GRE header. The length field in the UDP header 520 may indicate a length of the UDP datagram, which includes the UDP header 520 and an ESP packet including the ESP header 530, the modified GRE header 540, the payload 550, the ESP trailer 560, and the authentication data 570. The authentication data 570 may be used for authenticating the ESP header 530, the modified GRE header 540, the payload 550, and the ESP trailer 560. Although this disclosure describes a particular IPsec message with a payload comprising a modified GRE header as an interim header, this disclosure contemplates any suitable IPsec message with a payload comprising an interim header.

In some embodiments, a method for decrypting a message comprising a particular header and a tunnel-encapsulated message in an efficient manner may be using a decryption hardware based on length information determined from a length field in the particular header. In particular embodiments, the second network node may access a UDP packet comprising a payload that is ESP-encrypted. The payload is to be decrypted to be processed. In particular embodiments, the second network node may be an IPsec egress node for the payload. The payload may include a particular header and a first message. The first message may be an encapsulated message in accordance with a tunneling protocol. The second network node may determine that the payload comprising the particular header may be ESP encrypted based on at least a field in a UDP header of the UDP packet. In particular embodiments, the at least a field in the UDP header may include a field for a destination port number. As an example and not by way of limitation, continuing with a prior example, the IPsec egress node 420, at step 405, receives an IPsec message as illustrated in FIG. 5. The IPsec egress node 420 may be a cut-through device. The destination port number field in the UDP header 520 of the received IPsec message indicates that the payload of the UDP packet is ESP-encrypted, and the payload of the UDP packet includes a modified GRE header. The IPsec egress node 420 may determine that the payload of the UDP packet is ESP-encrypted, and the payload of the UDP packet includes a modified GRE header based on the destination port number in the UDP header. Although this disclosure describes accessing a UDP packet that is to be decrypted to be processed and determining the payload of the UDP packet is ESP-encrypted, and the payload includes an interim header in a particular manner, this disclosure contemplates accessing a UDP packet that is to be decrypted to be processed and determining the payload of the UDP packet is ESP-encrypted, and the payload includes an interim header in any suitable manner.

In particular embodiments, the second network node may decrypt first N bits of the payload using a decryption hardware. The first N bits of the payload may belong to the particular header. The decryption hardware may treat the first N bits of the payload as a part of an IPV4 header based on contents of the first N bits. In particular embodiments, N may be 32. The second network node may determine a length of the payload excluding the ESP trailer based on a length field value within the first N bits of the payload. As an example and not by way of limitation, continuing with a prior example, based on the determination that the payload of the UDP packet is ESP-encrypted, and the payload of the UDP packet includes a modified GRE header based on the destination port number in the UDP header 520, IPsec egress node 420 cause the decryption hardware to decrypt first 32 bits of the encrypted payload, which would be right next to the ESP header 530. Alternatively, the IPsec egress node 420 may cause the decryption hardware to decrypt first 64 bits of the encrypt payload, which would be entire modified GRE header 540. Upon decrypting the first 32 bits, which belong to the modified GRE header 540, the decryption hardware may treat the contents of the first 32 bits as a part of an IPV4 header based on the contents of the first 32 bits. For example, the first four bits ‘0100’ matches the version number of the IPV4 header. The decryption hardware may determine a length of encrypted payload excluding the ESP trailer 560 based on the total length field in the first 32 bits. Although this disclosure describes determining a length of encrypted payload excluding the ESP trailer in a particular manner, this disclosure contemplates determining a length of encrypted payload excluding the ESP trailer in any suitable manner.

In particular embodiments, the second network node may decrypt the payload using the decryption hardware based on the determined length of the payload. The second network node may separate the particular header and the first message among the payload that is decrypted. In particular embodiments, the reserved field of the particular header may be filled with ones. The second network node may determine that the particular header is to be discarded based at least on the reserved field. In particular embodiments, the second network node may determine that the particular header is to be discarded based on the at least a field in the UDP header. The second network node may determine the tunneling protocol based on a value of a protocol type field in the particular header. The second network node may remove an ESP header and the particular header. The second network node may also discard an ESP trailer including padding bytes. The second network node may process the first message in accordance with the determined tunneling protocol. As an example and not by way of limitation, continuing with a prior example, the decryption hardware of the IPsec egress node 420 may decrypt the payload based on the determined length of encrypted payload excluding the ESP trailer 560. The IPsec egress node 420 may separate the modified GRE header 540 and the tunnel-encapsulated message among the decrypted payloads. The IPsec egress node 420 may determine a tunneling protocol associated with the tunnel-encapsulated message based on the protocol type field in the modified GRE header 540. The IPsec egress node 420 may discard the ESP header 530 and the modified GRE header 540. The IPsec egress node 420 may also discard the ESP trailer 560 without decrypting the ESP trailer 560. The IPsec egress node 420 may process the tunnel-encapsulated message in accordance with the determined tunneling protocol associated with the tunnel-encapsulated message. Although this disclosure describes decrypting a payload comprising an interim header in a particular manner, this disclosure contemplates decrypting a payload comprising an interim header in any suitable manner.

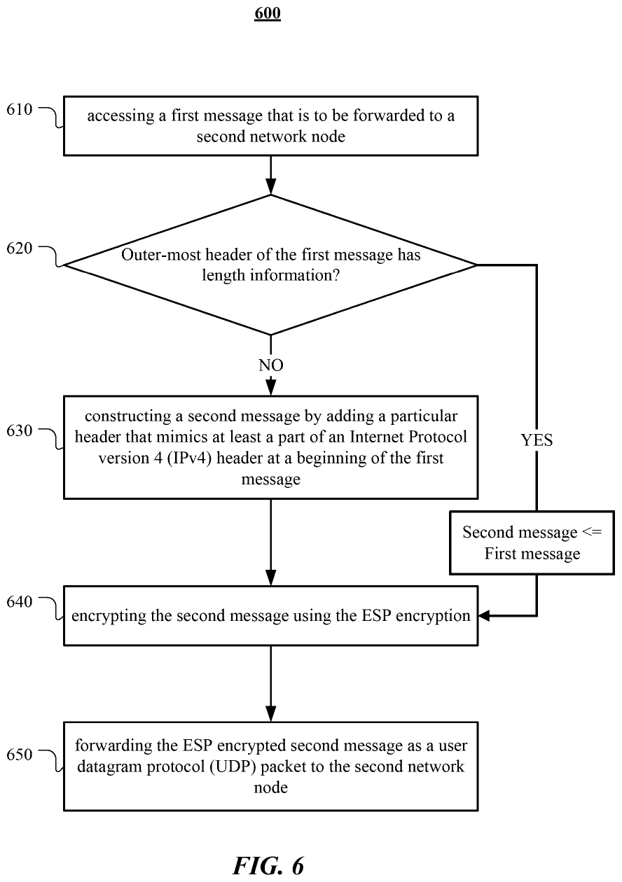

This disclosure describes systems and methods for encrypting a tunnel-encapsulated message by adding a particular header for an efficient decryption of the tunnel-encapsulated message at an egress node. FIG. 6 illustrates an example method 600 for encrypting a tunnel-encapsulated message by adding a particular header. The method may begin at step 610, where a first network node may access a first message that is to be forwarded to a second network node after being encrypted using an ESP encryption. At step 620, the first network node may determine whether an outer-most header of the first message has information regarding a length of the first message. If yes, the method proceeds to step 640 after setting the first message as a second message. If no, the method proceeds to step 630, where the first network node may construct a second message by adding a particular header that mimics at least a part of an Internet Protocol version 4 (IPv4) header at a beginning of the first message. The particular header may include a length field indicating a combined length of the particular header and the first message. At step 640, the first network node may encrypt the second message using the ESP encryption. At step 650, the first network node may forward the ESP-encrypted second message to the second network node as a UDP packet. At least a field in a UDP header of the UDP packet may indicate that the second message comprises the particular header and ESP-encrypted. Upon receiving the ESP-encrypted second message, the second network node may decrypt the second message using information on the particular header.

Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for encrypting a tunnel-encapsulated message by adding a particular header of the method of FIG. 6, this disclosure contemplates any suitable method for encrypting a tunnel-encapsulated message by adding a particular header including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

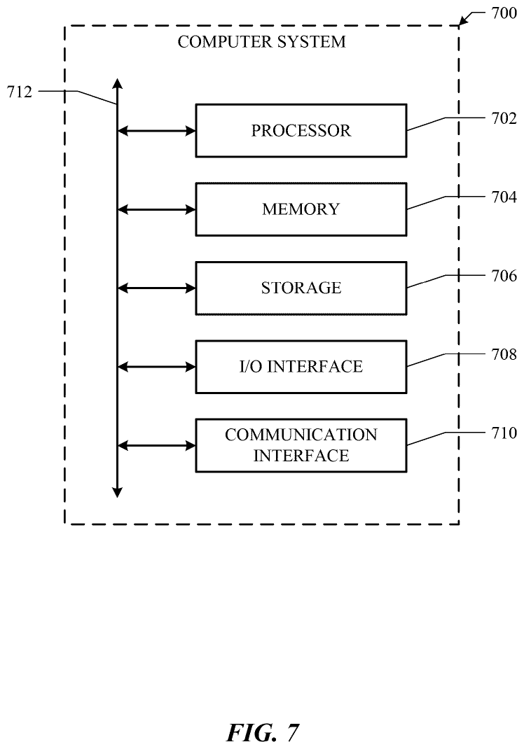

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a first network node,
accessing a first message that is to be forwarded to a second network node after being encrypted using an Encapsulating Security Payload (ESP) encryption;
determining that an outer-most header of the first message is lack of information regarding a length of the first message;
constructing a second message by adding a particular header that mimics at least a part of an Internet Protocol version 4 (IPv4) header at a beginning of the first message, wherein the particular header includes a length field indicating a combined length of the particular header and the first message;
encrypting the second message using the ESP encryption; and
forwarding, to the second network node, the ESP encrypted second message as a user datagram protocol (UDP) packet, wherein at least a field in a UDP header of the UDP packet indicates that the second message comprises the particular header and ESP-encrypted.

2. The method of claim 1, wherein the first network node is an IP Security (IPsec) ingress node for the ESP encrypted second message.

3. The method of claim 1, wherein the second network node is an IPsec egress node for the ESP encrypted second message.

4. The method of claim 1, wherein the first message is an encapsulated message in accordance with a tunneling protocol.

5. The method of claim 4, wherein the particular header comprises a protocol type field indicating the tunneling protocol.

6. The method of claim 4, wherein the tunneling protocol comprises Virtual extensible Local-Area Network (VxLAN), Multiprotocol Label Switching (MPLS), Generic User Datagram Protocol Encapsulation (GUE), Generic Network Virtualization Encapsulation (GENEVE), Generic Routing Encapsulation (GRE), or Network Virtualization using GRE (NVGRE).

7. The method of claim 1, wherein the particular header is a modified GRE header, wherein the particular header comprises 64 bits.

8. The method of claim 7, wherein first four bits of the particular header comprise a bit stream of ‘0100’.

9. The method of claim 7, wherein a version field of the particular header indicates one.

10. The method of claim 7, wherein a reserved field of the particular header is filled with ones.

11. The method of claim 1, wherein the at least a field in the UDP header includes a destination port number field.

12. A method comprising, by a second network node:
accessing a UDP packet comprising a payload that is ESP-encrypted, wherein the payload is to be decrypted to be processed, wherein the payload includes a particular header and a first message, and wherein the first message is an encapsulated message in accordance with a tunneling protocol;
determining, based on at least a field in a UDP header of the UDP packet, that the payload includes the particular header, and that the payload is ESP-encrypted;
decrypting, using a decryption hardware, first N bits of the payload, wherein the first N bits of the payload belong to the particular header;
determining, based on a length field value within the first N bits of the payload, a length of the payload excluding an ESP trailer;
decrypting, using the decryption hardware, the payload based on the length of the payload excluding the ESP trailer;
separating, among the payload that is decrypted, the particular header and the first message;
determining, based on a value of a protocol type field in the particular header, the tunneling protocol; and
processing the first message in accordance with the tunneling protocol.

13. The method of claim 12, wherein the decryption hardware treats the first N bits of the payload as a part of an IPV4 header based on contents of the first N bits.

14. The method of claim 12, wherein the decryption hardware discards an ESP trailer including any padding.

15. The method of claim 12, wherein the second network node is an IPsec egress node for the payload.

16. The method of claim 12, wherein the tunneling protocol comprises Virtual eXtensible Local-Area Network (VxLAN), Multiprotocol Label Switching (MPLS), Generic User Datagram Protocol Encapsulation (GUE), Generic Network Virtualization Encapsulation (GENEVE), Generic Routing Encapsulation (GRE), or Network Virtualization using GRE (NVGRE).

17. The method of claim 12, wherein the particular header is a modified GRE header, wherein the particular header comprises 64 bits.

18. The method of claim 12, wherein a reserved field of the particular header is filled with ones, and wherein the second network node determines that the particular header needs to be discarded based at least on the reserved field.

19. The method of claim 12, wherein the at least a field in the UDP header includes a destination port number field.

20. A first network node comprises:
one or more processors; and
one or more computer-readable non-transitory storage media coupled to one or more of the processors and comprising instructions operable when executed by one or more of the processors to cause the network node to:
access a first message that is to be forwarded to a second network node after being encrypted using an Encapsulating Security Payload (ESP) encryption;
determine that an outer-most header of the first message is lack of information regarding a length of the first message;
construct a second message by adding a particular header that mimics at least a part of an Internet Protocol version 4 (IPv4) header at a beginning of the first message, wherein the particular header comprises a length field indicating a combined length of the particular header and the first message;
encrypt the second message using the ESP encryption; and
forward, to the second network node, the ESP encrypted second message as a user datagram protocol (UDP) packet, wherein at least a field in a UDP header of the UDP packet indicates that the second message comprises the particular header and ESP-encrypted.
